(19) United States
(12) Patent Application Publication
(10) Pub. No.: US 2025/0081976 A1
(43) Pub. Date: Mar. 13, 2025

(54) SPIRAL CONVEYOR THERMAL PROCESSING SYSTEM

(71) Applicant: John Bean Technologies Corporation, Chicago, IL (US)

(72) Inventors: Ramesh Gunawardena, Solon, OH (US); Owen Eugene Morey, Huron, OH (US)

(73) Assignee: John Bean Technologies Corporation, Chicago, IL (US)

(21) Appl. No.: 18/729,686

(22) PCT Filed: Jan. 23, 2023
(86) PCT No.: PCT/US2023/061111

§ 371 Date: Jul. 17, 2024

Related U.S. Application Data
(60) Provisional application No. 63/267,067, filed on Jan. 24, 2022.

(51) Int. Cl. A23L 3/18; A23L 3/00; A23L 3/36; A23L 5/10; B65G 33/02; F24C 15/14; F24C 15/32

(52) U.S. Cl. CPC A23B 2/42; A23B 2/001; A23B 2/003; A23B 2/803; A23L 5/13; A23L 5/17; B65G 33/02; F24C 15/14; F24C 15/322; B65G 2207/24

(57) ABSTRACT

A thermal processing apparatus includes a conveyor belt for supporting work products during thermal processing that moves along a spiral path moving in a first direction arranged as a first tiered stack and then moves along a spiral path in a second direction arranged as a second tiered stack. A circulation system induces gaseous thermal processing medium from the tiers of the first and second spiral conveyor belt stacks and forces the thermal processing medium through a heat exchanger and then back to the tiers of the spiral conveyor belt stacks. The first tiered stack is divided into a first processing zone and a second processing zone, and the second tiered stack is divided into a third processing zone and fourth processing zone. A source of thermal processing medium is directed at the first processing zone to thermally treat the work product in the first zone by enhanced heat transfer. Optionally, a source of thermal processing medium is directed at the fourth processing zone to complete the thermally treatment the work product.

### CROSS-REFERENCE TO RELATED APPLICATION

This application claims the benefit of U.S. Provisional Application No. 63/267,067, filed on Jan. 24, 2022, the contents of which are incorporated herein by reference in its entirety.

### BACKGROUND

Spiral conveyor-based thermal processing systems include a heating surface or a cooling/freezing surface in the form of a pervious conveyor belt for conveying work pieces, including food, through a thermal processing chamber in spiral or helical paths. If the work piece is being cooked or otherwise heated, the heat source, such as steam, heated air, or mixtures thereof, is provided within or adjacent the cooking chamber for heating the work pieces. Correspondingly, if thermal processing is in the form of cooling or freezing, then the source of the cooling medium is provided either within the cooling/freezing chamber or adjacent thereto.

An advantage of thermal processing systems utilizing spiral conveyor belts is that a relatively long processing path may be achieved with a small footprint. For example, a 300-foot-long thermal processing conveyor belt in a spiral configuration can be contained within about a 10-foot high, 20-foot wide, and 40-foot long housing. The housing holds a first ascending spiral conveyor stack and a second descending spiral conveyor stack

However, spiral stack conveyor thermal processing systems do have some inherent drawbacks relative to a linear oven or freezer of a comparable length. In a linear oven or freezer, the upper and lower surfaces are exposed to being impinged upon by the thermal processing medium traveling at very high speeds, resulting in fast and efficient thermal transfer to the work product. However, in a spiral oven, the work products are not as directly accessible to the thermal processing medium since the work products are arranged in stacked layers or tiers, thus requiring a less direct thermal processing methods than direct impingement of the thermal processing medium onto the work product.

In spiral stack conveyor configurations, a fan system is used to direct the flow of thermal processing medium horizontally across the layers of the spiral stacks. The fan system is used to draw the processing medium across the stacks and then typically up to a location above the spiral stacks and through a heat exchanger to either heat or cool the thermal treating medium. Once exiting the heat exchanger, the treated medium is directed to flow downwardly along an exterior portion of the stacks diametrically opposite to the location of the circulating fans to draw the heating medium laterally into the spiral stacks and then across the spiral stacks.

As will be appreciated, this flow arrangement may not be as efficient in transferring thermal energy from the heated medium to the work product as in a linear oven. For instance, in an oven if convection heating is used, it may take quite some time for the work product to be sufficiently heated to cause the cooking process to progress very rapidly. Also, in a descending spiral stack, if moisture is drawn out of the work product, especially food products, if the moisture and/or fat is not evaporated at the exterior of the food product, the moisture and/or fat may drip down on the food products on a lower or lowest tier and contaminate or adulterate the food product or at least disfigure the food product as the food product leaves the spiral oven. The present disclosure seeks to address these short comings.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a schematic elevational view of an embodiment of the present disclosure, in partial cross-section, showing dual spiral conveyor stacks of an oven:

FIG. 1B is a schematic elevational view of an embodiment of the present disclosure, in partial cross-section, showing dual spiral conveyor stacks of a freezer cooler: FIG. 2A is a schematic top view of FIG. 1A, in partial cross-section;

FIG. 2B is a schematic top view of FIG. 1B, in partial cross-section: FIG. 3A is a graph of the surface temperature of work (food) products being heated using the spiral thermal processing system of the present disclosure:

FIG. 3B is a graph of the surface temperature of work (food) products being cooled using the spiral thermal processing system of the present disclosure:

FIGS. 4, 5, and 6 are computed psychometric properties at dry bulb temperatures of 212° F., 300° F., and 400° F. and at varying wet bulb temperatures: °

FIG. 7 is a comparison of specific enthalpies of humid air as a function of wet bulb at the three dry bulb temperature settings of FIGS. 4, 5, and 6.

### DETAILED DESCRIPTION

The description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well known process steps have not been described in detail in order not to unnecessarily obscure various aspects of the present disclosure. Further, it will be appreciated that embodiments of the present disclosure may employ any combination of features described herein.

The present application may include references to “directions,” such as “forward,” “rearward,” “front,” “back,” “ahead,” “behind,” “upward,” “downward,” “above,” “below,” “horizontal,” “vertical,” “top,” “bottom,” “right hand,” “left hand,” “in,” “out,” “extended,” “advanced,” “retracted,” “proximal,” and “distal.” These references and other similar references in the present application are only to assist in helping describe and understand the present disclosure and are not intended to limit the present invention to these directions.

The present application may include modifiers such as the words “generally,” “approximately,” “about,” or “substantially.” These terms are meant to serve as modifiers to indicate that the “dimension,” “shape,” “temperature,” “time,” or other physical parameter in question need not be exact, but may vary as long as the function that is required to be performed can be carried out. For example, in the phrase “generally circular in shape,” the shape need not be exactly circular as long as the required function of the structure in question can be carried out.

The present application refers to “work product or “workpiece” or “substrate” synonymously. One example of a work product or workpiece described in the present application is a food item or food product FP, such as, for example, beef, pork, poultry, fish, vegetables, fruits, and nuts.

In the following description and in the accompanying drawings, corresponding or similar systems, assemblies, apparatus, and units may be identified by the same part number, but with an alpha suffix or with a prime or double prime designation. The descriptions of the parts/components of such systems assemblies, apparatus, and units that are the same or similar are not repeated so as to avoid redundancy in the present application.

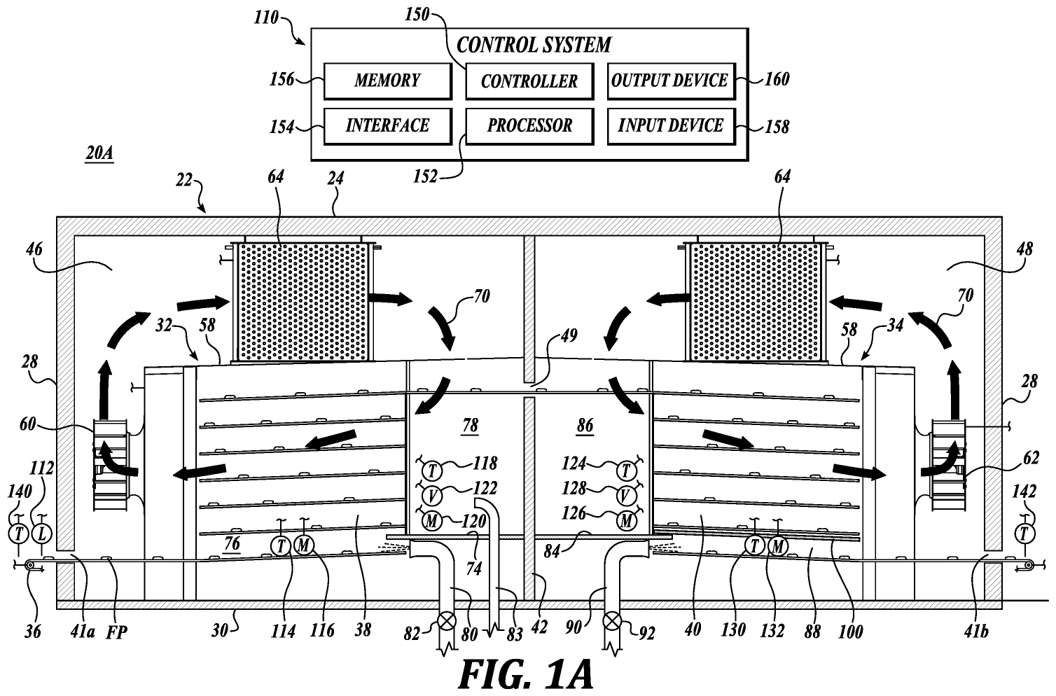

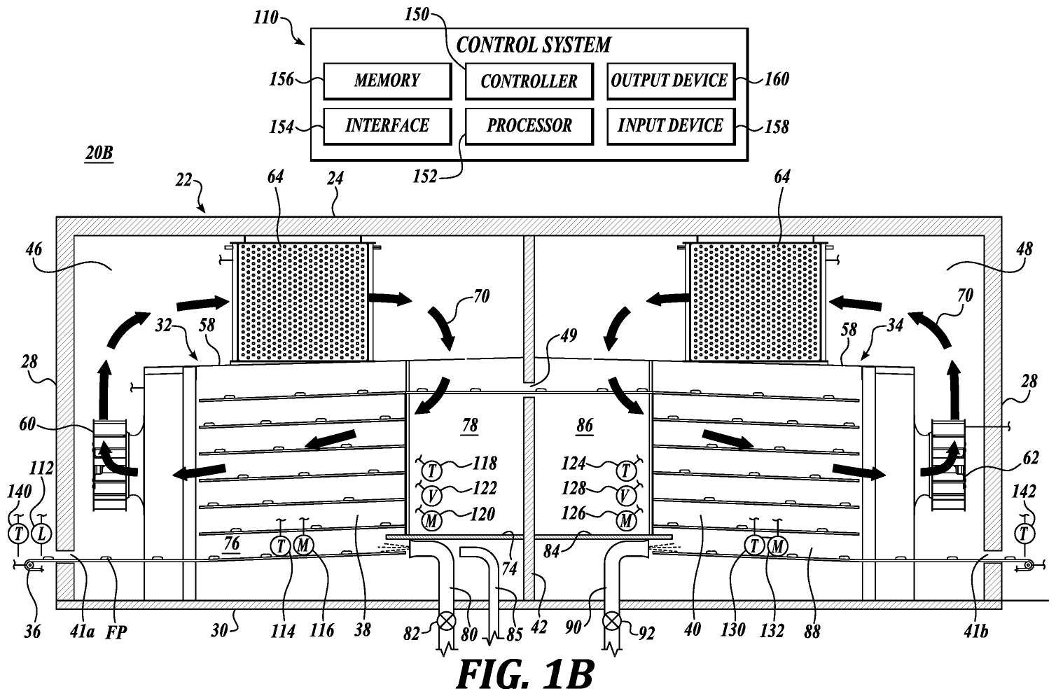

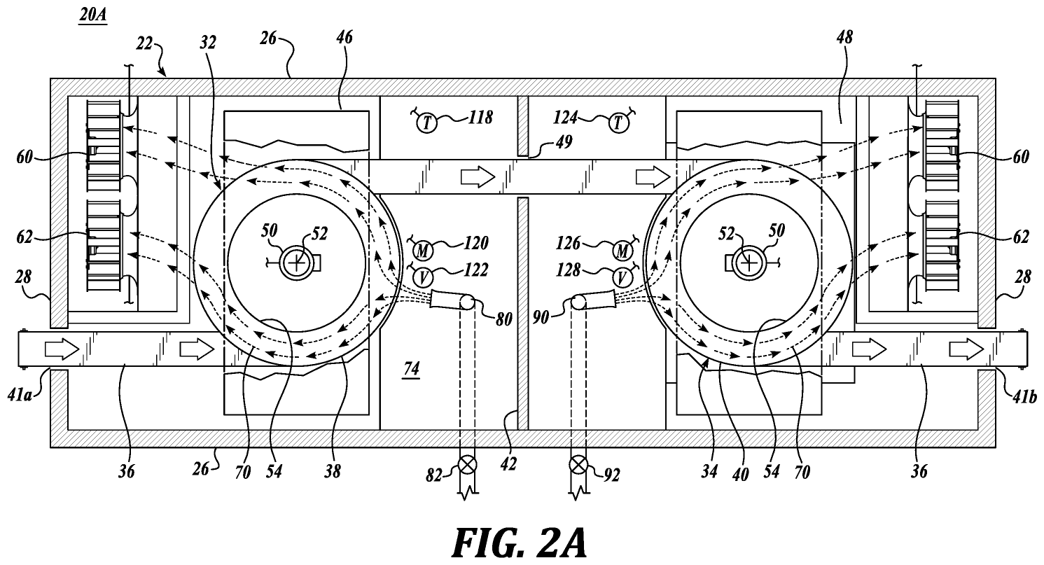

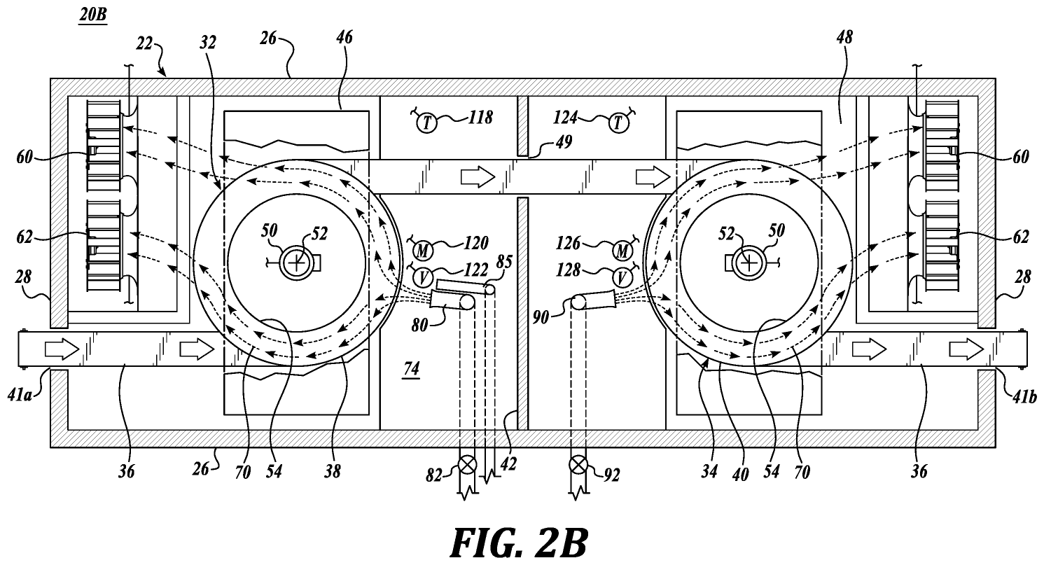

Referring initially to FIGS. 1A, 1B, 2A, and 2B, embodiments of thermal processing apparatus 20A and 20B are illustrated as including a generally rectangularly shaped housing 22 having a top section or ceiling 24, longitudinal side sections or walls 26, and transverse end sections or walls 28, as well as a floor 30. The housing 22 is sized to contain first and second spiral or helical conveyor units 32 and 34.

A continuous powered conveyor belt 36 for carrying work products through the apparatus 20 is arranged in tiers forming an ascending spiral stack 38 in conveyor unit 32 and arranged in tiers forming a descending spiral stack 40 in conveyor unit 34. As shown in FIGS. 1A and 1B, the conveyor belt 36 enters the spiral conveyor unit 32 at the bottom thereof at an inlet 41a in wall 28 and then travels in a spiral path until reaching the top of the spiral stack 38, and then extends tangentially from the top of stack 38 to the top stack 40 to descend along the spiral conveyor unit 34 to eventually exit the unit 34 from the bottom tier of the stack 40 through outlet 41b form in wall 28. The inlet 41a and outlet 41b can be substantially sealed from the ambient by air knives or other means.

A center or mid wall 42 divides the two spiral conveyor units 32 and 34 into separate compartments 46 and 48 wherein different process media conditions can be employed. For example, the temperature of the air, air/vapor mixture, steam, or other processing medium, the moisture content in the air, the medium velocity, etc., may be different in the two compartments created by the mid or cross wall 42. A close fitting opening 49 is provided in wall 42 to allow passage of the conveyor belt 36 and the work products being carried thereon. If needed, an air knife or similar/other sealing system can be used to provide a seal between the two compartments 46 and 48.

As shown in FIGS. 2A and 2B, the center of the conveyor stacks 38 and 40 extend around a central drive system 50 that rotates the conveyor units 32 and 34 about a central axis 52. The drive system 50 includes a cylindrical drive drum 54 that frictionally and rotationally drives conveyor belt 36 over supports (not shown) that are fixed in place exterior to the drum, thereby to rotate the belt about axis 52. The belt 36 tightens around the drive drum 54, creating enough friction therebetween to drive the belt forward to slide over the supports.

A top panel structure 58 overlies the conveyor stacks 38 and 40. Circulation fans 60 and 62 are positioned at outward sides of the conveyor units 32 and 34 to draw processing medium, for example, air, across the interior of the conveyor stacks 38 and 40 (and around drum 54) so as to thermally treat the work products being carried on the conveyor belt 36 and then direct such processing medium upwardly along the end walls 28 of the housing 22 toward the ceiling 24 of the housing. Thereafter, the processing medium is directed through a heat exchanger 64 positioned on or above the top panel structure 58. The processing medium extends transversely across the top of each of the stacks 38 and 40. The heat exchanger 64 may be mounted on or just above the structure 58 by an appropriate mounting structure.

The thermal processing air or other thermal processing medium, being circulated by the fans 60 and 62, when passing through the heat exchanger 64, is either cooled or heated as desired. The heated or cooled processing medium flows horizontally over the top structure 58 until reaching the cross wall 42, wherein the processing medium is deflected downwardly to flow along the exposed adjacent portion of the conveyor stacks 38 and 40 and enter into the stacks in a lateral direction, as depicted by arrows 70, thereby heating or cooling the work product primarily by convection heat transfer.

The spatial arrangement of the fans 60 and 62, the heat exchanger 64, and optimally positioned partition 42 in relation to the respective stacks enables flow distribution to be uniform to each tier within the individual stacks to deliver air flow mixture to approach the surfaces of the food items on the conveyor diagonally. This serves as a unique feature with respect to conventional twin-drum ovens manufactured by others.

A first mezzanine 74 is located in the lower portion of chamber or compartment 46 to effectively divide the conveyor stack 38 into a lower first processing zone 76 below the mezzanine and an upper second processing zone 78 above the mezzanine. The mezzanine extends outwardly from the mid wall 42 toward the conveyor stack 38. As shown in FIGS. 2A and 2B, a central portion of the mezzanine is scalloped or otherwise relieved to provide clearance for the conveyor stack 38. The remainder of the mezzanine 74 (located beyond the conveyor stack 38) extends towards the center of the conveyor stack to approximately the location of the drive drum 54.

The first mezzanine 74 is shown as substantially planar in construction. Appropriate braces or reinforcements can be used to provide the needed structural integrity of the mezzanine.

Optionally, the mezzanine 74 is adjustable in elevation by an appropriate actuating system. Preferably, the actuation system is powered so the control system, discussed below; is able to alter the height of the second mezzanine as desired. FIGS. 1A and 1B show the first mezzanine 74 as located at an elevation between the first and second lowest tiers of the conveyor stack 38. However, the first mezzanine 74 can be positioned at a higher elevation, for example, at the level of the second lowest tier or at a level above the second lowest tier of the conveyor stack 38.

A thermal processing medium delivery conduit or pipe 80 is shown in FIG. 1A as delivering thermal processing medium in the form of saturated or superheated steam that is under pressure at the point of discharge to the lower first processing zone 76 for enhanced thermal processing of the work product. If the apparatus 20A is used as an oven, then the thermal processing apparatus may be in the form of steam. The rate of steam flow from the pipe can be controlled by adjusting a valve 82, which is schematically shown as located near the outlet of the pipe 80. The steam supply pressure is controlled using an adjustment valve to between 10-60 PSIG and ideally between 10-20 PSIG. In cooking, optionally the sensed control variable is the humidity level in the zone 76. In cooking, this enables the steam to expand to atmospheric conditions to deliver an instantaneous dew point temperature of 212° F. more readily for interacting with the incoming work product (food items) on the entering conveyor. This is due to the lesser amount of de-superheating required at lower steam pressures.

The steam flowing from pipe 80, which fills the lower volume of zone 76 or 88 and then eventually flowing into the fans 60 or 62, functions to advantageously heat the work product by condensation heat transfer, which is capable of transferring heat to the work product very quickly, and much more rapidly than by convection heat transfer. In this regard, the heat transfer coefficient for steam condensation heat transfer is 2700 Kcal/hr-M2-° C., whereas the heat transfer coefficient for forced convection heat transfer is 30 to 35 Kcal/hr-M2-° C. Of course, condensation heat transfer stops when the work product reaches the dew point temperature, and thereafter convection heat transfer is required.

Preferably, the steam delivered by pipe 80 is saturated steam at atmospheric temperature, so that the high heat transfer coefficient noted above can be utilized. The saturated steam used can be controlled to a desired steam temperature based on type of substate being processed. For example, for products with high fat content such as pork, it may be desirable to employ a saturated steam temperature that is lower than 212° F. early on in the process to control the product yield loss associated with surface fat, since fat starts to melt at lower temperatures in the range of 131-135° F. Moreover, food items are processed to optimize a combination of things, such as desired product attributes, product yields, and throughputs. As a result, the process conditions needed to achieve these objectives are path specific, requiring suitable operating parameters for the defined zones.

For example, in zone 76—condensation conditions dictated by substrate specificity: in zone 78—convection conditions that compliment condensation conditions employed in zone 76 for the substrate: in zone 86 (discussed below) for convection finish cooking; and finally in zone 88 (also discussed below)-conditions to enable for equilibrated product temperatures to come out of the physical limits of the oven discharge.

However, it must be noted that the highest energy transfer onto the surfaces of food items occurs through condensation at or around the highest dew point temperature which is 212° F. This is true irrespective of the type of substrate being processed, as long as the surface temperature is below the actual dew point temperature being used for the process. The adjustable mezzanine can be set so low in such a way that entering gases (steam or other) can bypass the first zone 76 with the result of only mixing in the fan(s) and adding to overall mixture proportions with gas mixture unmodified by relevant exposure to food items.

In addition to the efficient use of steam to achieve condensation heat transfer in processing zone 76, the steam to at least some extent can also mix with the heated air in processing zone 78 to boost the enthalpy level in processing zone 78 for enhanced heating of the work product (food product) while in the processing zone 78. See Example 1 below.

Further, if it is desired to have more steam in processing zone 78 than available from leakage from zone 76, steam can specifically be supplied to zone 78 by, for example, a steam delivery pipe or conduit 83, as schematically shown in FIG. 1A. In this case, since condensation heat transfer is not being relied upon, the steam can be supplied at a higher pressure, for example, from about 60-80 PSIG.

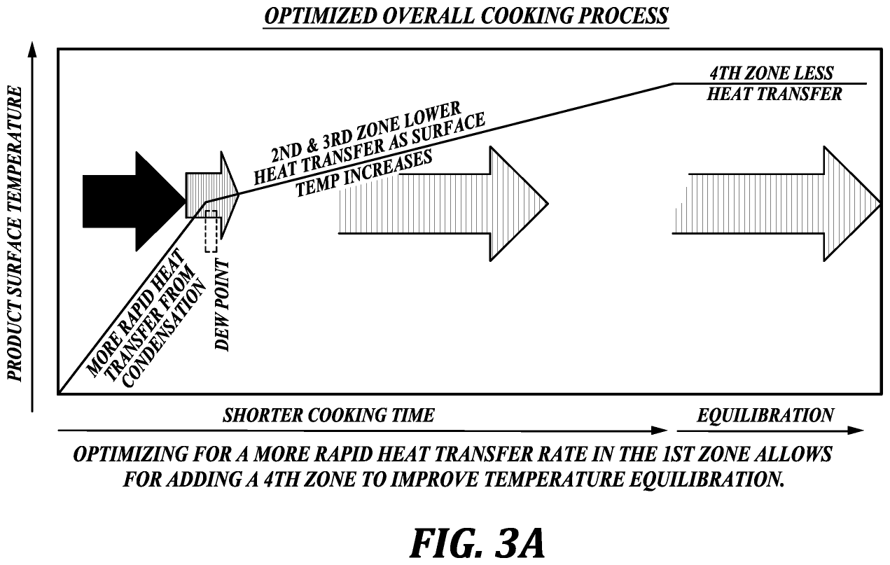

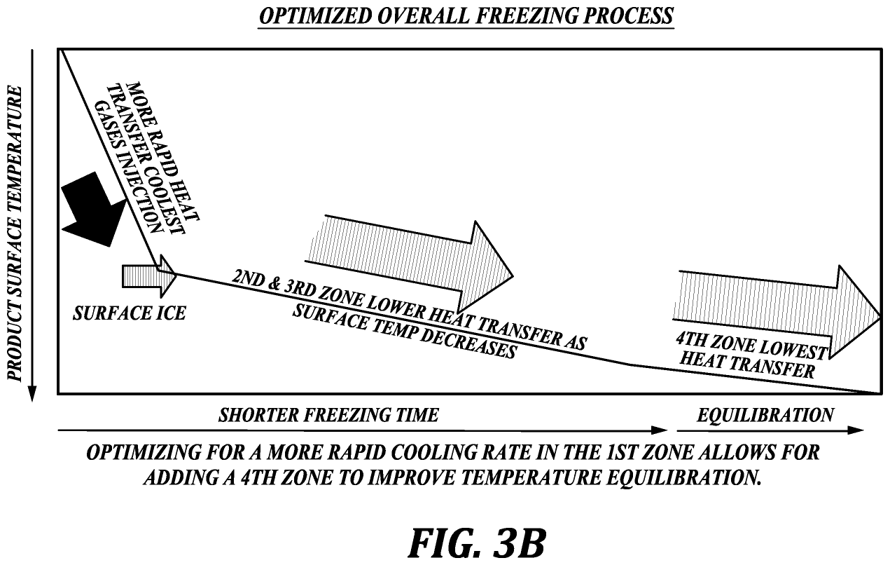

FIG. 3A shows a graph of heat transfer during cooking a food product. As illustrated, the surface temperature of the food product rises much more rapidly during the condensation heat transfer phase than during the subsequent convection heat transfer phase in zones 78 and 86. Zone 86 is discussed below.

If the apparatus 20B is used as a cooler or freezer, then the work products in processing zone 76 may be treated by cold and dry air or other refrigerant, such as a cryogenic gas, entering the processing zone 76 via delivery pipe 85. Pipe 85 optionally could be fitted with a manifold in a form suitable for efficient distribution with multiple nozzles directed toward zone 76. This rapidly initiates the chilling/cooling of the work product (food product) to a temperature of approximately 10° C. [50° F.] or colder. The rapid cooling of the food product can result in a crust forming on the exterior surface of the food product, thereby preventing moisture release from the food product. In this manner, the moisture level within processing zone 78 can be maintained at a sufficiently low level so that the rate of frost deposition on the freezer coils of the thermal processing unit/heat exchanger 64 will be minimized or at least reduced. As a consequence, the apparatus can be operated for a longer cycle before it will be necessary to defrost the thermal processing unit 64, resulting in a shorter downtime of the apparatus.

Also, likely at least some of the refrigerant gas introduced in processing zone 76 will flow into processing zone 78 to create some level of modification to the overall convection gas mixtures constituency in zone 78.

In freezing/cooling applications, pipe 80 optionally can be used to supply steam to zone 76 to create heating for the cleaning process. In freezers pathogen ingress occurs from the infeed via various mechanisms which justifies having sanitation steam heating placed in zone 76.

FIG. 3B shows a graph of heat transfer during cooling of a food product. As illustrated, the surface temperature of the food product lowers much more rapidly during the heat transfer phase in zone 76 than during the subsequent cooling heat transfer phase in zones 78 and 86. Zone 86 is discussed below.

A second mezzanine 84 is located in the lower portion of chamber 48 to effectively divide the conveyor stack 40 into a third upper processing zone 86 and a fourth lower processing zone 88. The mezzanine extents outwardly from the mid wall 42 toward the conveyor stack 40. As shown in FIGS. 2A and 2B, a central portion of the mezzanine 84 is scalloped or shaped to provide clearance for the conveyor stack 40. The remainder of the mezzanine extends towards the center of the conveyor stack to approximately the location of the drive drum 54.

The second mezzanine 84 is also shown as substantially planar in construction. Appropriate braces or reinforcements can be used to provide the needed structural integrity of the mezzanine.

Optionally, the mezzanine 84 is adjustable in elevation, via an appropriate actuation system. Preferably the actuation system is powered so the control system, discussed below, is able to alter the height of the second mezzanine as desired. FIGS. 1A and 1B show the second mezzanine 84 as located at an elevation between the first and second lowest tiers of the conveyor stack 40. However, the mezzanine 84 can be positioned at a higher elevation, for example, at the level of the second lowest tier or above the second lowest tier.

A thermal processing medium delivery conduit or pipe 90 is shown in FIGS. 1A and 1B as delivering thermal processing medium to the lower fourth processing zone 88 for enhanced thermal processing of the work product. If the apparatus 20A is used as an oven, then the thermal processing apparatus may be in the form of steam. The rate of steam flow from pipe 90 can be controlled by adjusting a valve 92, which is schematically shown. If required, the steam from pipe 90 functions to advantageously heat the work product by condensation heat transfer. It may be that the work product has already reached the desired maximum temperature by the time the work product has reached the fourth processing zone 88, in which case additional heating by steam from pipe 90 is not needed.

If the apparatus 20B is used as a cooler or freezer, then the thermal processing apparatus may be in the form of air at a temperature significantly colder than the temperature of air produced by heat exchanger 84, thereby to rapidly initiate the chilling/cooling of the work product. It may be that the work product has already reached the desired minimum temperature by the time the work product has reached the fourth processing zone 88, in which case additional enhanced cooling is not needed.

As shown in FIG. 1A, an annular shaped barrier 100 is positioned just below the second tier from the bottom in conveyor stack 40. The barrier 100 functions to catch liquid drippings from the tiers located above the barrier. Such drippings typically consist of moisture and fat drippings from the interior of the work product which has not evaporated when reaching the exterior surface of the work product. If such drippings were allowed to fall on to the work products as the work products are leaving the housing 22, such adulteration of the work product may be unacceptable visually, as well from a sterilization point of view.

The barrier 100 can take various forms, for example, the barrier can be generally in the form of an annularly shaped sheet that is mounted relative to the conveyor stack 40 by mounting brackets or other means. The barrier 100 can be positioned at a slope to direct the dripping to a collection location. The barrier is shown as sloped to match the slope of the tiers. However, the barrier can be at a different slope than the tiers so as to facilitate the flow of the liquid drippings to a collection location.

Alternatively, the barrier can in the form of a shallow truncated cone, so that the drippings flow to the outer perimeter of the barrier for collection.

Although the barrier 100 is shown as located below the second lower most tier of conveyor stack 40, the barrier can be at different elevation relative to the stack 40. For example, the barrier may be located just below the third lower most tier of the conveyor stack. In this case, the second mezzanine 84 could be located at the elevation of the barrier 100.

A control system 110 is employed to control the operation of the apparatus 20 to help insure that the work products (food products FP) are properly thermally, for example, are cooked to achieve desired product core temperature and qualities consisting of sensory attributes such as color, flavor, texture, mouthfeel, etc., via in-oven conveyor path solution and resulting temperature equilibration. Consequently, pathogenic microorganisms which may be present on the surface and/or in the interior of food product FP are killed to a sufficient level. The control system 110 receives input signals from various measurement devices or instruments of a monitoring system that monitors, among other process parameters, the temperature, air/vapor mixture velocity, and moisture content within the housing 22 at various locations, the temperature of the food product, the speed of the conveyor belt 36, and the level of loading of food products on the conveyor belt, as discussed more fully below.

The measuring system of the apparatus 20 measures the operational parameters of apparatus, including the loading frequency or density of the food product FP loaded onto the conveyor belt 36 from a delivery conveyor, not shown. Such load monitor or sensor is schematically symbolized by the load monitor/sensor 112 shown in FIGS. 1A and 1B.

The load monitor/sensor 112 can take various forms, including a scale to weigh the food product being transferred to conveyor belt 36. Alternatively, the load monitor can be in the form of an optical scanner capable of scanning the food product and determining the volume of the food product, then calculating the weight of the food product by using the known density of the food product. Such scanning systems are well known in the art. For example, see U.S. Pat. No. 7,452,466. The disclosure of this patent is incorporated herein by reference. The information from the load monitor 112 is transmitted to the control system 110.

The measuring system also measures the temperature and moisture level within the various processing zones 76, 78, 86, 88 of the conveyor stacks 38 and 40, as well as the velocity of the air/vapor mixture flowing through the convection processing zones 78 and 86. These operational parameters can be measured by temperature sensor 114 and moisture sensor 116 in the lower first processing zone 76. A temperature sensor 118, a moisture sensor 120, and a fluid velocity sensor 122 can be utilized in upper second heating zone 78. Correspondingly, a temperature sensor 124, a moisture sensor 126, and a fluid velocity sensor 128 can be utilized in upper third processing zone 86. Also, correspondingly, temperature sensor 130 and moisture sensor 132 can employed in the fourth lower processing zone 88. These sensors are in communication with the control system 110, which can be by hard wiring or wireless transmission. Of course, alternative and/or additional sensors can be employed.

One or more of the temperature sensors 114, 118, 124, and 130 preferably are configured to sense the dry bulb and wet bulb temperatures within their respective processing zones. The reason for also measuring the wet bulb temperature is that as the food product is carried through the apparatus 20, its surface temperature gradually increases. Eventually, this surface temperature will reach the dew point temperature of the moist, hot air in the processing zone. At that point, the moisture in the heating medium within the processing zone will not condense on the surface of the food products. Instead, the moisture on the surface of the food products will begin to evaporate, which tends to cool the food product somewhat. The temperature at which this transition occurs will be the wet bulb temperature. Nonetheless, the energy delivered to the surfaces of the food product must still be sufficient to cook the food product to the desired target temperature while achieving sensory attributes sought and also kill the desired level of pathogens on and/or in the food product FP. As an alternative, the monitoring system can measure the dry bulb temperature and humidity level in the processing zones. From this information it is possible to determine the wet bulb temperature, relative humidity, and dew point within the processing zones.

The measuring system can also be configured to measure the initial temperature of the food products FP entering the first lower processing zone 76 by, for example, the use of a temperature measuring device 140. Likewise, the measuring system can also be configured to measure the final temperature of the food products exiting the fourth lower processing zone 88 by, for example, the use of a temperature measuring device 142. These sensors also are in communication with the control system 110.

As schematically depicted in FIGS. 1A and 1B, the control system 110 includes a controller 150 for use in controlling the operation of apparatus 20. The control system also includes a processor 152 linked to the controller. An appropriate interface 154 is provided for connecting the various gauges, measuring devices, and components of the apparatus 20 to the controller 150. A memory unit 156 is provided for storing information regarding the apparatus 20, and a keyboard or other input device 158 is provided to enable the operator to communicate with the processor and controller. Such information can include a recipe for the type of food product being processed and desired end parameters for the fully processed food product. Such recipes for achieving the end parameters can be stored in the memory unit 156. Also, a display or other output device 160 is provided to convey information from the processor or control system to the operator, including the functioning of the apparatus 20. An example of a processor-operated control system for controlling a cooking apparatus is disclosed by U.S. Pat. No. 6,410,066, which is incorporated herein by reference.

The measuring system also measures, and the control system 110 controls, the components of the apparatus 20 so as to operate within set point parameters, including the speed of the conveyor belt 36, the speed of the fans 62, the operation, including the thermal output, of the heat exchanges 64, and the quality and volume of steam from delivery pipes 80 and 90. These components are in communication with the control system 110. This can be accomplished by wired connection or wirelessly.

The control system 110, more specifically the processor 152 together with the controller 150, controls the various components and subsystems of apparatus 20, including the level of the loading of the food product onto the conveyor belt 36, by controlling the operation of a loading conveyor that delivers the food product to the conveyor belt. The control system 110 also controls the speed of the conveyor belt 36 by controlling the conveyor drive system 50. The speed of the conveyor belt affects the dwell time of the work products in the various processing zones of the apparatus 20.

In addition, the control system controls the temperature and moisture level within the lower processing zones 76 and 88 by controlling quality and volume flow rate of the thermal processing medium (steam) introduced into these processing zones. The control system also controls temperature and flow rate of the convection thermal processing medium in the upper second and upper third processing zones by controlling the temperature, volume, and speed of the hot air circulated through these processing zones.

Based on the foregoing it is must be understood that the steam conditioning employed in processing zones 76, 78, and 86 are both independent yet interdependent when physical zone segregation is employed. These interdependencies also provide opportunities to adjust the convective conditions in processing zones 78 and/or 86 based on the steam or other modifying gas condition and residence time employed during condensation to accommodate substate specific objectives. Substrate specific objectives are having high heating rate as with cooking or having high cooling rate as with freezing.

For example, if the substrate specificity of a pork-based food item requires slightly less intense condensation heat transfer early on in the process when the product is initially in the raw state and vulnerable to greater amounts of fat loss, especially fat that is close to the surface, it may be desirable to apply a modified temperature, velocity, and process humidity combination in processing zones 78 and/or 86 where the food item is in a partially or close-to a-fully cooked state or form where more fat may be retained within the food items, therefore reducing the fat loss. Empirical evidence supports this substrate behavior. However, these moisture losses can also be manipulated through ingredient additions to bind both water and fat.

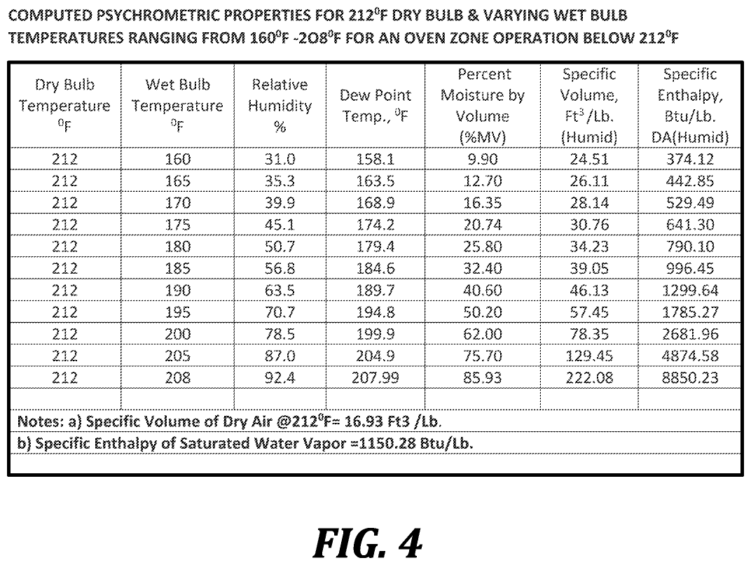

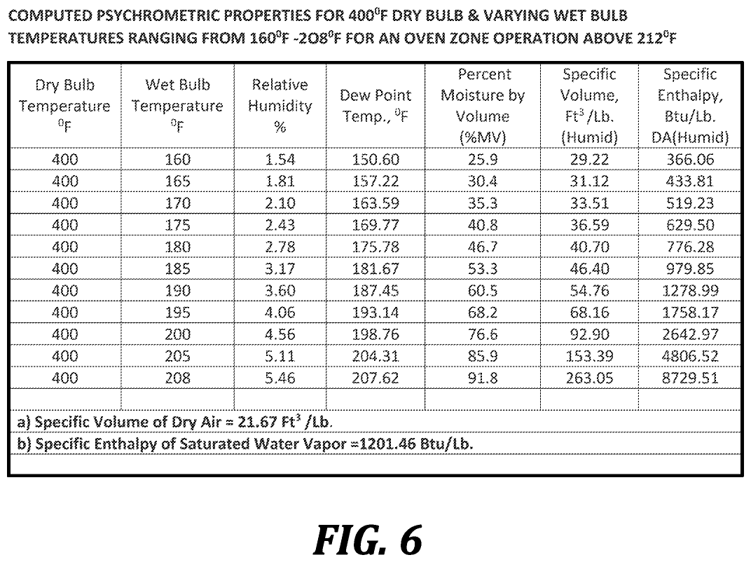

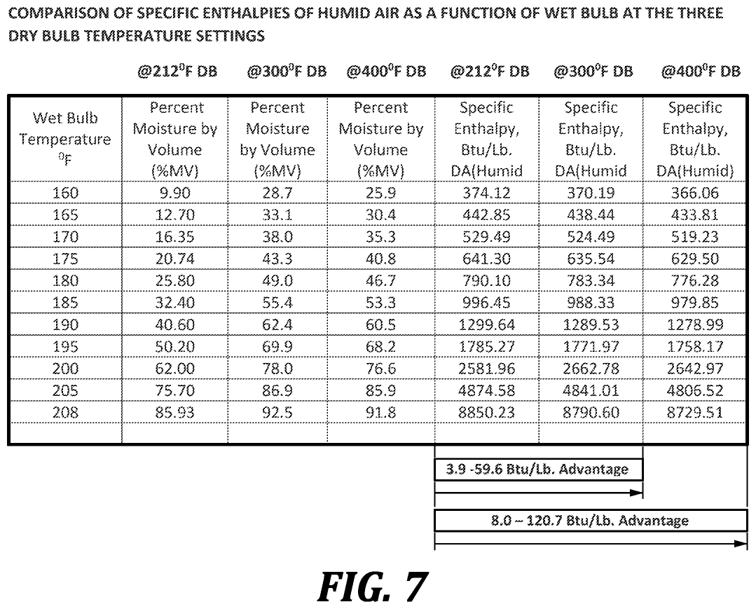

FIGS. 4-6 show the total energy available in humid (moist) air and psychrometric properties at three dry bulb temperatures as a function of their wet bulb temperature. Therein, the enthalpy is a term used to describe the total amount of heat present in an air-vapor mixture. It is the sum of both the sensible and latent heat present in the air. These figures show that at each of the temperatures (212° F., 300° F., and 400° F.), the available energy increases rapidly at higher wet bulb temperatures. So, referring back to the discussion above, the energy transfer during the convection stage in processing zone 78 can be adjusted higher by using a higher wet bulb temperature to at least partially overcome the heat transfer deficiency arising from less intense lower saturation temperature in processing zone 76. This is an inherent advantage provided by zone segregation. An integrated or singular zone has less flexibility.

The control system also monitors the loading sensor 112, the various temperature sensors 114, 118, 124, 130, 140, and 142, the various moisture sensors 116, 120, 126 and 132, as well as the processing fluid velocity sensors 122 and 128. Thus, the control system is capable of controlling the apparatus 20 and the cooking and pasteurization process performed by the apparatus 20 to achieve desired level of cooking of the food product FP as well as a targeted reduction in the pathogenic microorganisms present on and/or in the food product FP.

The process parameters of the various components and processing zones of the apparatus 20 can be determined in advance and stored in the memory 156 of the control system for various types of work products as well as various sizes and other physical parameters of the work product. As one example, the process parameters of the various components and processing zones of the apparatus 20 can be determined in advance for cooking chicken breasts of a specific size range, loading density, and initial temperature, so that when the chicken breasts exit the apparatus 20 they are cooked to the desired level and/or the desired pathogen kill level has been achieved.

Further, if one or more process parameters are measured to not be within the desired set point range, or if the work product leaving the apparatus 20 is not at the desired temperature range or level, then the control system is capable of adjusting the operational settings of the systems and/components of the apparatus 20 to achieve the set point range and/or temperature of the work product exiting the apparatus 20. The control system can temporarily alter the set point range of one or more systems or components of the apparatus 20 in an effort to rectify the processing of the work product still being processed by the apparatus 20.

For example, if the temperature of the work product leaving the apparatus is below the set point range, the speed of the conveyor belt can be slowed to provide a longer dwell time of the food product within the housing 22. Alternatively, the heat exchanger in the compartment 48 can be controlled to transfer more heat energy to the work product in the upper third processing zone. In addition, or further alternatively, the quantity of steam delivered from steam pipe 90 can be raised to increase the heating of the work product in the fourth processing zone. Of course, other adjustments to the apparatus 20 may be made.

### Example 1

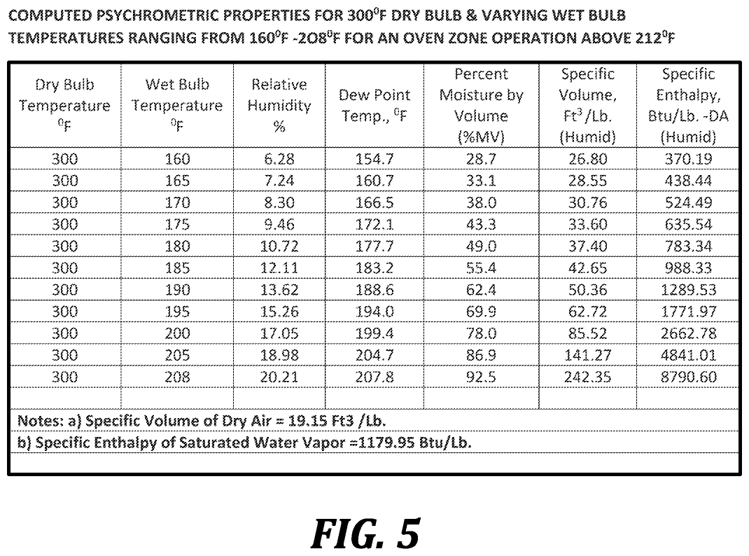

As a baseline, the operating conditions nominally in processing zone 78 is at a temperature of 300F and a humidity of 55% moisture by volume. Computed psychrometric properties at three different nominal operating conditions of apparatus 20 are set forth in FIGS. 4, 5, and 6. The above operating conditions are shown in FIG. 5, which specifies that under these operating conditions the wet bulb temperature will be 185° F. and the specific enthalpy will be 988.33 Btu/Lb.-DA.

Assuming that in processing zone 76 steam is supplied at a dry bulb temperature of 212° F., at a wet bulb temperature of 200° F., and a flow rate of 100 SCFM, the psychrometric conditions in zone 76, the base line conditions in zone 78, and the “mixture” conditions in zone 78 due to the steam introduced in zone 76 are set forth in the following table:

Combined Zones 76 & 78 (Mixture):

| | Zone 76 | Zone 78 | |
|---|---|---|---|
| | Air Stream | Air Stream | Mixture |
| Dry Bulb Temp. ° F. | 212 | 301 | 299.74 |
| Wet Bulb Temp. ° F. | 200 | 185 | 185.23 |
| Medium Flow Rate | 100 | 14,900 | 15,000 |
| % MV | * | 55 | 55 |
| BTU/LB. (Humid Air) | 2681.96 | 988.3 | 1004.1 |
| | (Ref. FIG. 4) | (Ref. FIG. 5) | |
| Enhancement BTU/LB | | | 15.8 |

As set forth in the above table, the specific enthalpy in processing zone 78 has been increased from 988.3 to 1004.1 BTU/Lb. In sum, the introduction of steam in processing zone 76 provides for not only the efficient use of steam for condensation heat transfer to the work product, but also an energy boost for the heating medium in zone 78 due to the mixing of some of the steam from zone 76 into zone 78.

While illustrative embodiments have been illustrated and described, it will be appreciated that various changes can be made therein without departing from the spirit and scope of the invention. For example, it may be that the fourth processing zone and the related second mezzanine are not needed, with the work product being sufficiently processed within the third processing zone.

Also, although the work product is illustrated in FIGS. 1A and 1B as entering chamber 46 from the bottom of spiral stack 38 and exiting chamber 48 from the bottom of spiral stack 40, the work product could enter the chamber 46 from the top of spiral stack 38 and likewise exit the chamber 48 from the top of spiral stack 40. In this case the barrier 100 would not be needed. However, the mezzanines 74 and 84 could still be utilized; but rather than being located between the lower most and second lowermost tiers, the mezzanines could instead be located between the upper most and second upper most tiers. In this case the locations of processing zone 76 and 88 would be located at the top of the stacks 38 and 40 rather than at the bottom, as shown in FIGS. 1A and 1B. Also, in this case the steam inlet pipes 80 and 90 would be located above the uppermost tiers of stacks 38 and 40, rather than at the locations shown in FIGS. 1A and 1B.

Although the present disclosure has focused on the apparatus 20 as being in the form of an oven, the apparatus could instead be in the form of a freezer. In this case, the barrier 100 would not be needed. Further, the volumetric addition of via delivery pipes 80 and 90, the steam heating could be replaced by streams of very cold air or cryogenic inert gas entering at a temperature substantially below the temperature of the air exiting the heat exchangers 64.

1. A thermal processing apparatus, comprising:
a. a conveyor belt for supporting work products during thermal processing, the conveyor belt moving along a spiral path moving in a first direction arranged as a first tiered stack and moving along a spiral path in a second direction arranged as a second tiered stack;
b. a circulation system to induce a gaseous first thermal processing medium from the tiers of the first and second spiral conveyor belt stacks and forces the thermal processing medium through a heat exchanger and then back to the tiers of the spiral conveyor belt stacks;
c. the first tiered stack divided into a first processing zone and a second processing zone; and
d. a source of second thermal processing medium directed at the first processing zone to thermally treat the work product in the first zone by enhanced heat transfer.

2. The thermal processing apparatus of claim 1, further comprising the first mezzanine dividing the first tiered stack into a first processing zone and a second processing zone.

3. The thermal processing apparatus of claim 2, wherein the second thermal processing medium from the second thermal processing medium source is directed to the first processing zone.

4. The thermal processing apparatus of claim 2, where in the first mezzanine is adjustable in elevation relative to the first tiered stack.

5. (canceled)

6. The thermal processing apparatus of claim 1:
wherein the second tiered stack is divided into a third processing zone and a fourth processing zone; and
a source of a third thermal processing medium directed at the work product of the fourth processing zone.

7. The thermal processing apparatus of claim 6, wherein the second and third thermal processing media are selected from that group consisting of heated air, steam, saturated steam, supersaturated steam, cooled air, chilled air, refrigerated cold air, cryogenically refrigerated air, and cryogenic gases.

8. The thermal processing apparatus of claim 6, further comprising a second mezzanine to divide the second tiered stack into the third processing zone and the fourth processing zone.

9. The thermal processing apparatus of claim 8, wherein third thermal processing medium is directed at the work product located in the fourth processing zone.

10. (canceled)

11. The thermal processing apparatus of claim 1, wherein the source of the second thermal processing medium is directed at the first processing zone to heat the work product in the first zone by condensation heat transfer.

12. The thermal processing apparatus of claim 11, further comprising a helically shaped barrier located between adjacent tiers of the second spiral stack to catch liquids dropping down from overhead tiers located above the barrier to prevent the liquids from falling on the work products located beneath the barrier.

13-15. (canceled)

16. The thermal processing apparatus of claim 6, further comprising a measuring system to measure the operation of the thermal processing apparatus, including one or more operational parameters selected from the group consisting of: the work product loading level on the conveyor belt; the speed of the conveyor belt; a temperature within at least one of the first, second, third, and fourth processing zones; a moisture level within at least one of the first, second, third, and fourth processing zones; a velocity of the first thermal processing medium in at least one of the second and third processing zones; the quality and volume flow rate of the at least one of the second and third processing fluids in at least one of the first and fourth processing zones; the temperature of the work product entering the thermal processing apparatus; the temperature of the work product exiting the thermal processing apparatus.

17. The thermal processing apparatus of claim 16, further comprising a control system monitoring the measured one or more of the operational parameters of the thermal processing apparatus and controlling the monitored one or more operational parameters.

18. A method of thermal processing work products, comprising:
a. supporting work products on a powered conveyor belt for moving along a first spiral path arranged as a first tiered stack and then moving along a second spiral path arranged as a second tiered stack;
b. inducing a gaseous first thermal processing medium from the tiers of the first and second spiral conveyor belt stacks and forcing the thermal processing medium through a heat exchanger and then back to the tiers of the spiral conveyor belt stacks;
c. dividing the first tiered stack divided into a first processing zone and a second processing zone; and
d. directing a second thermal processing medium at the first processing zone to thermally treat the work product in the first processing zone by enhanced heat transfer.

19. The method of claim 18, wherein the second thermal processing medium is selected from that group consisting of heated air; steam, saturated steam, supersaturated steam, cooled air, chilled air, refrigerated cold air, cryogenically refrigerated air, and cryogenic gases.

20. The method of claim 18, further comprising dividing the first tiered stack into a first processing zone and a second processing zone with a first mezzanine.

21. The method of claim 20, further comprising directing the second thermal processing medium to the first processing zone beneath the first mezzanine.

22. (canceled)

23. The method of claim 18, further comprising:
dividing the second tiered stack into a third processing zone and a fourth processing zone; and
directing a third thermal processing medium at the work product of the fourth processing zone.

24. (canceled)

25. The method of claim 23, further comprising dividing the second tiered stack into a third processing zone and a fourth processing zone using a second mezzanine.

26. (canceled)

27. The method of claim 18, wherein directing second thermal processing medium at the first processing zone to heat the work product in the first processing zone by condensation heat transfer.

28. The method of claim 27, further comprising catching liquids dropping down from overhead tiers of the second spiral stack to prevent the liquids from falling on the work products located at a lower tier of the second spiral stack.

29-30. (canceled)

31. The method of claim 25, further comprising measuring the operation of the thermal processing apparatus, including measuring one or more operational parameters selected from the group consisting of: a work product loading level on the conveyor belt; a speed of the conveyor belt; a temperature within at least one of the first, second, third, and fourth processing zones; a moisture level within at least one of the first, second, third, and fourth processing zones; a velocity of the first thermal processing medium in at least one of the second and third processing zones; a quality and volume flow rate of at least one of the second and third processing fluids in at least one of the first and fourth processing zones; a temperature of the work product entering the thermal processing apparatus; a temperature of the work product exiting the thermal processing apparatus.

32. The method of claim 31, further comprising monitoring the measured one or more of the operational parameters of the thermal processing apparatus and controlling the monitored one or more operational parameters.
